(19) United States
(12) Patent Application Publication
(10) Pub. No.: US 2015/0308820 A1
(43) Pub. Date: Oct. 29, 2015

(54) Bubble Level

(71) Applicant: Mark L. Silberberg, Fallbrook, CA (US)

(72) Inventor: Mark L. Silberberg, Fallbrook, CA (US)

(21) Appl. No.: 14/703,049

(22) Filed: May 4, 2015

Related U.S. Application Data
(63) Continuation-in-part of application No. 13/925,584, filed on Jun. 24, 2013.

(51) Int. Cl. G01C 9/26

(52) U.S. Cl. CPC G01C 9/26

(57) ABSTRACT

A bubble type level for determining the orientation of a structure that includes first and second differently oriented bubble vials that are secured within the level body in a manner such that if either of the bubble vials become broken or otherwise damaged, it can be easily replaced and the level need not be discarded. The bubble type level of the invention also includes a novel connector mechanism that enables the level to be removably interconnected with the structures to be leveled, such as conduit. The level further includes a plurality of longitudinally spaced magnets that are connected to the bottom surface of the level body and a bulls-eye level that is mounted on the top surface of the level body.

### CROSS-REFERENCE TO RELATED APPLICATIONS

This is a Continuation In Part of co-pending U.S. application Ser. No. 13/925,584 filed Jun. 24, 2013.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to tools used in the construction industry. More particularly, the invention concerns a specially designed bubble level having replaceable bubble vials and including a novel connector mechanism for releasably connecting the level to the structure to be leveled.

2. Description of Related Art Including Information DISCLOSED UNDER 37 CRF 1.97 AND 1.98

Bubble levels of various designs have been suggested in the past and are widely used by construction workers to determine the orientation of a particular structure or surface with respect to a reference axis. A typical bubble level generally comprises an elongated body that has a pair of opposing, generally parallel working surfaces and includes a plurality of openings having bubble vials permanently secured therein. The bubble vials are typically aligned in different directions relative to the working surfaces and function to indicate the orientation of a structure. For example, one vial may be aligned in a direction perpendicular to the working surfaces, another may be aligned in a direction parallel to the working surfaces and a third may be aligned in an angular direction. Typically, the vial contains a fluid and a bubble, and the user views the position of the bubble within the vial to determine the position of the tool relative to the working surfaces.

A novel and highly useful level construction is disclosed in U.S. Pat. No. 7,802,372 issued to the present inventor. This patent, which is entitled “Removable Laser Base Attachment for Bubble Levels”, describes a bubble level that includes a body, a laser beam generator, and a removable securement. The body has a flat top surface that the level is secured to and a bottom surface that is flat and parallel to the top surface. A laser diode mounted in a module emits a visible laser beam upon application of power from a battery that is controlled by a switch. The module, batteries, and switch are mounted in a through bore in the body. The laser base is removably secured to the bubble level by any manner appropriate to the shape of the level. In one such securement, the level has a T-shaped cross-section and the body has a complementary slot into which the level slides. When the level reference surface abuts the top surface of the laser base, a thumb screw is tightened to frictionally secure the level in the base.

### BRIEF SUMMARY OF THE INVENTION

It is an object of the present invention to provide a bubble type level for determining the orientation of a structure that includes a plurality of differently oriented bubble vials that are secured within the level body in a manner such that, if any one of the bubble vials become broken, or otherwise damaged, it can be easily replaced and the level need not be discarded.

Another object of the invention is to provide a bubble type level of the afore mentioned character in which the bubble vials are securely held in position within chambers formed in the level body by a bayonet mount consisting of a generally cylindrical male component having a pair of radial pins, and a female receptor component with matching L-shaped slots. A strategically located spring functions to keep the two parts locked together. The slots are typically provided in the shape of a capital letter L with a short upward segment at the end of the horizontal arm. In use, the pin slides into the vertical arm of the L, rotates across the horizontal arm, then is pushed slightly upwards into the short vertical segment by the spring.

Another object of the invention is to provide a bubble type level of the character described which includes a slotted end portion within which the novel connector mechanism is mounted that enables the level to be removably interconnected with structures to be leveled, such as a length of conduit.

Another object of the invention is to provide a bubble type level of the character described in the preceding paragraph in which the novel connector mechanism further includes a rotating ball-and-spring device that is connected to the level proximate the slotted end portion thereof.

Still another object of the invention is to provide a bubble type level of the class described that includes a plurality of longitudinally spaced magnets that are connected to the bottom surface of the level so as to permit the level to be conveniently, removably connected to any ferrous structure that is being leveled.

Yet another object of the invention is to provide a bubble type level of the type described in the preceding paragraphs that includes a bulls-eye level that is mounted on the top surface of the level body proximate the center of the level.

These and other objects of the invention will be realized by the level construction illustrated in the drawings and described in the paragraphs that follow.

### BRIEF DESCRIPTION OF SEVERAL VIEWS OF THE DRAWINGS

FIG. 1 is a side elevational view of one form of the leveling device of the invention.

FIG. 2 is a left end view of the leveling device shown in FIG. 1.

FIG. 3 is a right end view of the leveling device shown in FIG. 1.

FIG. 4 is a top plan view of the leveling device shown in FIG. 1.

FIG. 5 is a bottom plan view of the leveling device shown in FIG. 1.

FIG. 6 is a side elevational, exploded view partially in cross-section of the leveling device of the invention.

FIG. 7 is a greatly enlarged, side elevational view of the spring-ball-screw component of the leveling device of the invention.

FIG. 8 is a fragmentary, cross-sectional view of the right end portion of an alternate form of the leveling device of the invention.

FIG. 9 is a side elevational view of an alternate form of leveling device of the invention.

FIG. 10 is a left end view of the leveling device shown in FIG. 9.

FIG. 11 is a right end view of the leveling device shown in FIG. 9.

FIG. 12 is a top plan view of the leveling device shown in FIG. 9.

FIG. 13 is a bottom plan view of the leveling device shown in FIG. 9.

FIG. 14 is a side elevational, exploded view partially in cross-section of the leveling device of the embodiment shown in FIG. 9.

FIG. 15 is a view taken along lines 15-15 of FIG. 14.

FIG. 16 is a greatly enlarged view of area designated in FIG. 14 as 16-16.

FIG. 17 is a generally perspective view of the alternate form of leveling device shown in FIG. 9 when interconnected with a length of conduit.

### DETAILED DESCRIPTION OF THE INVENTION

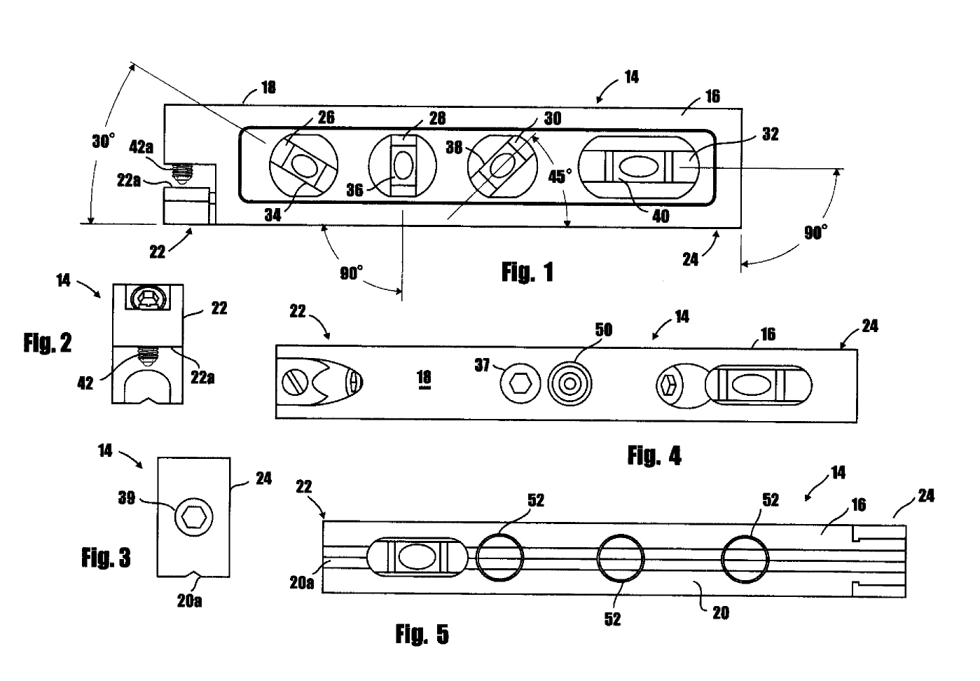

Referring to the drawings and particularly to FIGS. 1 through 6, one form of the level of the invention for determining the orientation of a structure is there shown and generally designated by the numeral 14. Level 14 here comprises an elongate body 16 having a top surface 18, a bottom surface 20 and first and second end portions 22 and 24, respectively. For a purpose presently to be discussed, first end portion 22 is provided with a slot 22a. As best seen in FIGS. 3 and 5, bottom surface 20 is provided with a longitudinally extending, generally “V” shaped groove 20a.

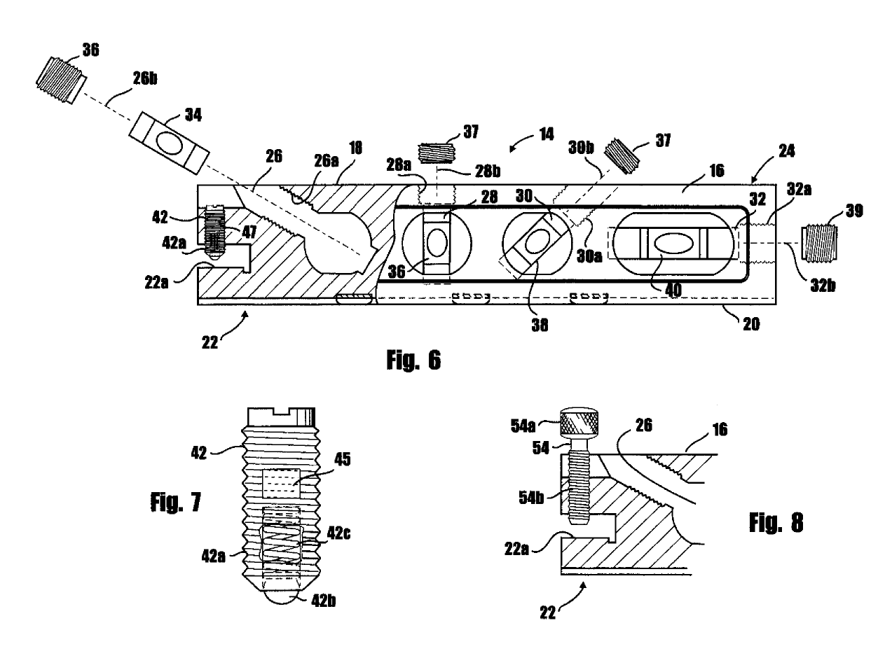

As best seen in FIGS. 1 and 6 of the drawings, body 16 has a plurality of differently oriented vial chambers 26, 28, 30 and 32. Vial chamber 26 has a threaded end portion 26a and a central axis 26b that is disposed at an angle of approximately 38 degrees with respect to bottom surface 20. Vial chamber 28 has a threaded end portion 28a and a central axis 28b that is disposed at an angle of approximately 90 degrees with respect to bottom surface 20. Vial chamber 30 has a threaded end portion 30a and a central axis 30b that is disposed at an angle of approximately 45 degrees with respect to bottom surface 20. Vial chamber 32 has a threaded end portion 32a and a central axis 32b that is disposed in a generally parallel relationship with bottom surface 20. It is to be understood that the angles of the axes of the central axis of each of the vial chambers can vary depending upon the end use of the improved level.

A conventional bubble vial 34 is disposed within vial chamber 26 and is uniquely removably secured there within by a threaded connector that is threadably receivable within threaded opening 26a of vial chamber 26. The threaded connector, which is here provided in the form of a conventional cap screw 36 (FIG. 6), is moveable between first and second positions to secure the bubble vial 34 within vial chamber 26 (FIG. 1). A conventional bubble vial 36 is disposed within vial chamber 28 and is uniquely removably secured there within by a threaded connector that is threadably receivable within threaded opening 28a of vial chamber 28. The threaded connector, which is also here provided in the form of a conventional cap screw (FIGS. 3 and 6), is moveable between first and second positions to secure the bubble vial 36 within vial chamber 28 (FIG. 1). In similar manner, a conventional bubble vial 38 is disposed within vial chamber 30 and is uniquely removably secured there within by a threaded connector that is threadably receivable within threaded opening 30a of vial chamber 30. Once again, the threaded connector is provided in the form of a conventional cap screw 37 (FIGS. 3 and 6) that is moveable between first and second positions to secure the bubble vial 38 within vial chamber 30 (FIG. 1).

In like manner, as shown in FIG. 1, a conventional bubble vial 40 is disposed within vial chamber 32 and is removably secured there within by a conventional cap screw 39 (FIG. 6) which is moveable between first and second positions to secure the bubble vial 40 within vial chamber 32.

With the construction thus described, any one of the bubble vials of the level can be conveniently removed and replaced by simply removing the threaded cap screw from the threaded end portion of the vial chamber and then by removing the bubble vial from its chamber. Unlike the prior art levels, if a given bubble vial is broken or otherwise damaged, it can be easily replaced and the level need not be discarded.

Another highly important feature of the present invention resides in the provision of a connector mechanism for releasably interconnecting body 16 with the structure to be leveled. The connector mechanism, which is here provided in the form of a conventional, self-contained ball-and-spring device 42, is threadably connected to body 16 proximate first end portion 22. As depicted in FIG. 7, the self-contained ball-and-spring device 42 has a threaded shank portion 42a that, when the device is threadably connected to the level body, at least partially extends into slot 22a of the first end portion of the body (FIG. 6). Ball-and-spring device 42 also includes a ball 42b and a biasing spring 42c that are arranged in the manner illustrated in FIG. 7.

As illustrated in FIG. 7, shank portion 42a of the ball-and-spring device 42 includes a nylon patch 45 that functions to prevent the device from accidentally moving within threaded portion 47 of the end portion 22 due to vibration.

Self-contained ball-and-spring devices 42, which are suitable for the present purpose, are readily commercially available from several sources including the Carr Lane Manufacturing Co. of St. Louis, Mo.

Turning now to FIG. 4 of the drawings, another important feature of the present invention resides in the provision of a bulls-eye level 50 that is mounted on the top surface 18 of body 16 proximate the center of the level. Bulls-eye level 50 is readily commercially available from several sources including the Johnson Level & Tool Mfg. Co., Inc. of Mequon, Wis.

Referring to FIG. 5, still another important feature of the present invention resides in the provision of a plurality of longitudinally spaced magnets 52 that are connected to the bottom surface 20 of body 16. In use, these magnets permit the level to be conveniently, removably connected to any ferrous structure that is being leveled. Magnets 52 are readily commercially available from several sources including Applied Magnets of Plano, Tex.

Turning now to FIG. 8, an alternate form of connector mechanism for releasably interconnecting body 16 with the structure to be leveled is there shown. This alternate form of connector mechanism is provided in the form of a conventional screw 54 that has a knurled head 54a and threaded shank portion 54b. When the device is threadably connected to the level body 16 in the manner shown in FIG. 8, threaded shank portion 54b at least partially extends into slot 22a of the first end portion of body 16.

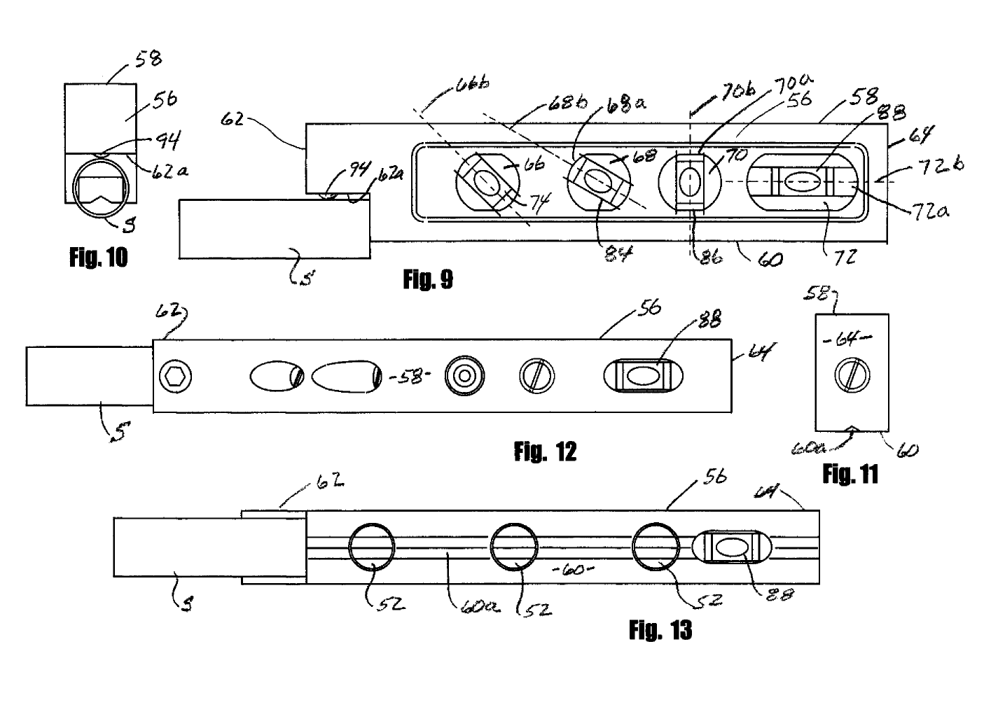

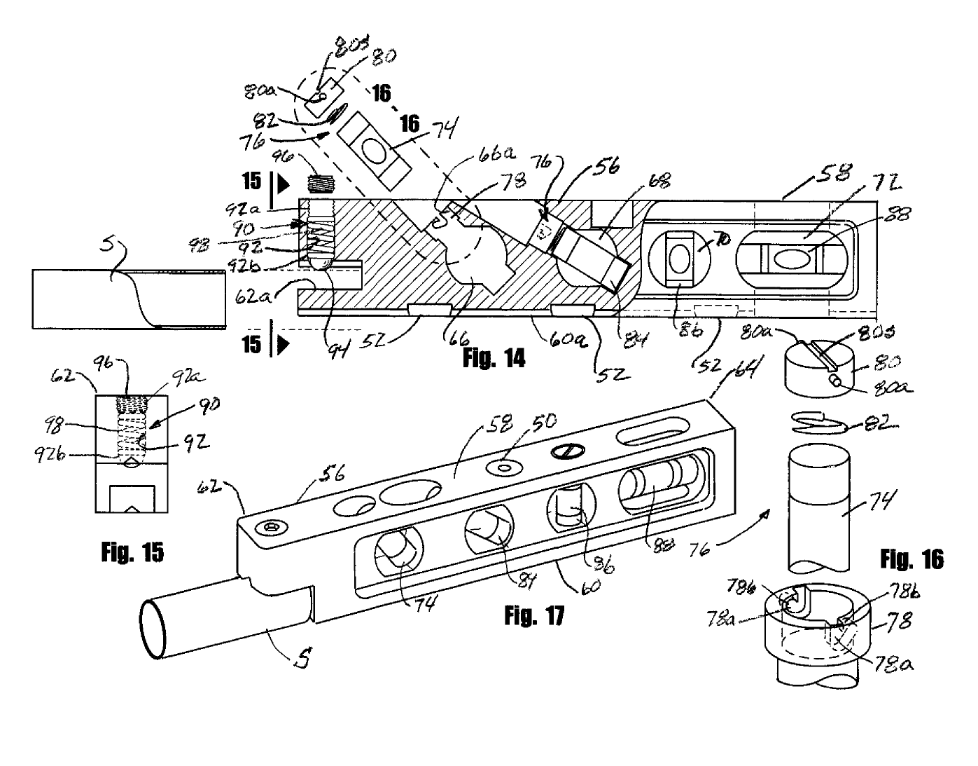

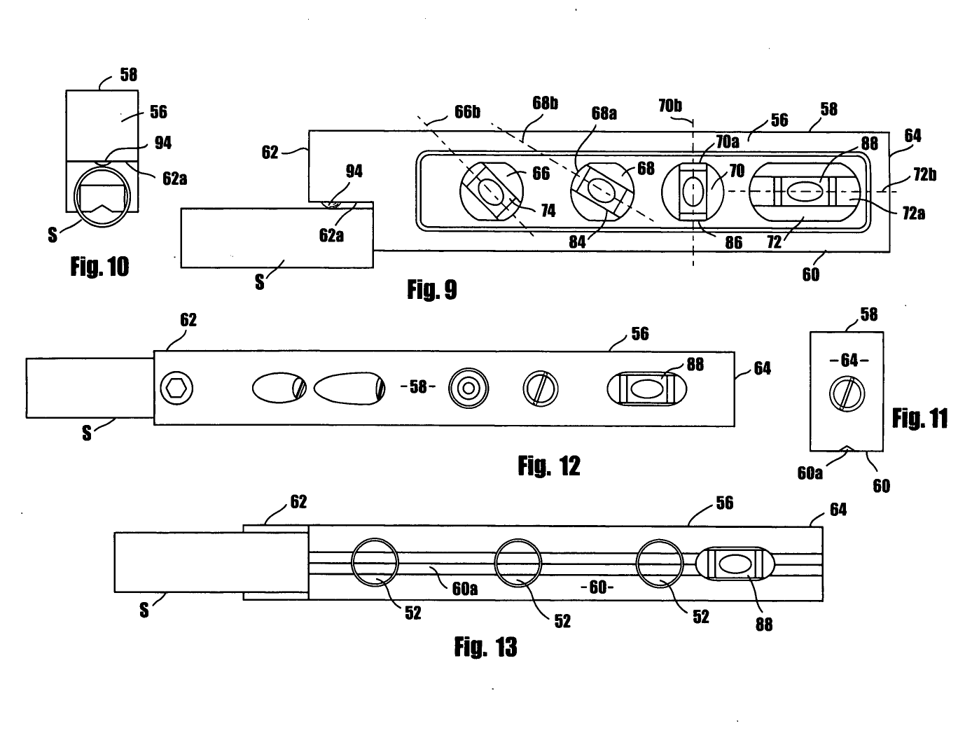

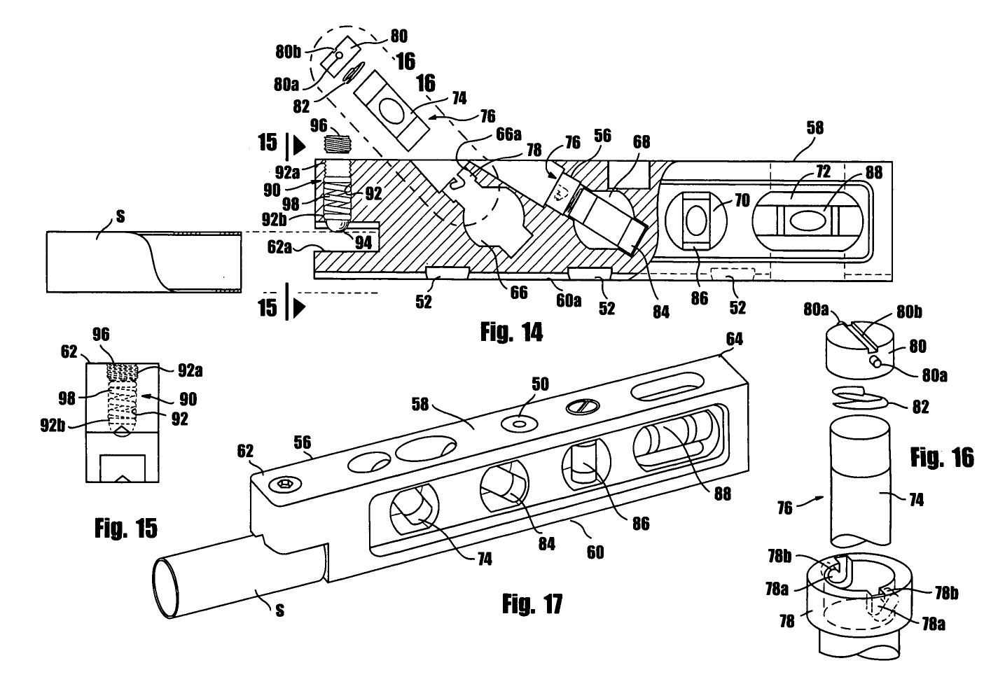

Turning now to FIG. 9, an alternate form of leveling device of the invention is there shown. This device, which is similar in many respects to the leveling device shown in FIGS. 1 through 5, comprises an elongate body 56 having a top surface 58, a bottom surface 60 and first and second end portions 62 and 64, respectively. For a purpose presently to be discussed, first end portion 62 is provided with a slot 62a (FIG. 14). As best seen in FIGS. 11 and 13, bottom surface 60 is provided with a longitudinally extending, generally “V” shaped groove 60a. When the level is used to orient structures such as conduit, the “V”-shaped groove functions to longitudinally align the level with the conduit.

As best seen in FIGS. 9 and 14 of the drawings, body 56 has a plurality of differently oriented vial chambers 66, 68, 70 and 72. Vial chamber 66 has an opening 66a and a central axis 66b that is disposed at an angle of approximately 38 degrees with respect to bottom surface 60. Vial chamber 68 has an opening 68a and a central axis 68b that is disposed at an angle of approximately 90 degrees with respect to bottom surface 60. Vial chamber 70 has an opening 70a and a central axis 70b that is disposed at an angle of approximately 45 degrees with respect to bottom surface 60. Vial chamber 72 has an opening 72a and a central axis 72b that is disposed in a generally parallel relationship with bottom surface 60. It is to be understood that the angles of the axes of the central axis of each of the vial chambers can vary depending upon the end use of the improved level.

A conventional bubble vial 74 is disposed within vial chamber 66 and is uniquely removably secured there within by a bayonet like connector mechanism 76. As depicted in FIG. 15 of the drawings, this novel bayonet like connector mechanism 76 here comprises a female receptor 78 that is connected to body 56 proximate the opening 66a in the vial chamber 66 and a generally cylindrically shaped male connector 80 that is operably associated with bubble vial 74 in the manner illustrated in FIG. 14 of the drawings. As best seen by referring to FIG. 15, female receptor 78 has a pair of circumferentially spaced apart generally L shaped slots 78a and male connector 80 has a pair of circumferentially spaced apart radial pins 80a that, in a manner presently to be described, are receivable within the generally L-shaped slots of the female receptor. Also forming a part of the connector mechanism of this form of the invention is a coil spring 82 that is disposed between male connector 80 and bubble vial 74.

In using the connector mechanism 76 to removably secure the bubble vial 74 within chamber 66, the bubble vial is first inserted into the vial chamber 66 via the chamber opening 66a and is seated against the inner end wall of the vial chamber. This done, the coil spring 82 is positioned in engagement with the bubble vial and the pins 80a of the male connector 80 are aligned with the slots 78a of the receptor. To couple the male connector with the female receptor, the male connector is pushed inwardly against the urging of the coil spring until the pins 80a reach the bottom of the slots 78a formed in the female receptor. Once the pins are seated within the slots, the male connector 80 is rotated so that the pin slides along the horizontal arm of the Ls until it reaches the serifs 78h. The spring 82 will then function to urge the pins, upwardly within the serifs so as to keep the pins locked into place. As indicated in the drawings, the upper surface of the male connector is provided with a transversely extending slot 80s to enable the use of the screwdriver to conveniently rotate the male connector relative to the female receptor. With the construction thus described, a user can quickly and easily secure the bubble vial within its vial chamber. Unlike screw connectors, the connector mechanisms of this latest form of the invention are not subject to cross-threading. To disconnect, the male connector from the female receptor, an inward pressure exerted against the male connector will cause the locking pins to move out of the serifs 78h, so as to allow rotation of the male connector in the opposite direction and enable separation of the components and easy removal of the bubble vial.

As best seen in FIGS. 9 and 18 of the drawings, a conventional bubble vial 84 is disposed within vial chamber 68 and is uniquely removably secured there within by a connector mechanism that is of substantially identical construction and operation to the connector mechanism 76. Similarly, a conventional bubble vial 86 is disposed within vial chamber 70 and is uniquely removably secured there within by a connector mechanism that is of substantially identical construction and operation to the connector mechanism 76.

In similar manner, a conventional bubble vial 88 is disposed within vial chamber 72 and is uniquely removably secured there within by a connector mechanism that is of substantially identical construction and operation to the connector mechanism 76.

With the construction thus described, any one of the bubble vials of the level can be conveniently removed and replaced through operation of the bayonet like connector mechanism 76 previously described herein. Accordingly, if a given bubble vial is broken or otherwise damaged, it can be easily replaced and the level need not be discarded.

Turning now to FIG. 18 of the drawings, another important feature of this latest form of the invention resides in the provision of a bulls-eye level 50 that is mounted on the top surface 58 of body 56 proximate the center of the level. Bulls-eye level 50, which is substantially identical in construction and operation to that described in connection with the embodiment of FIGS. 1 through 8, is readily commercially available from several sources including the Johnson Level & Tool Mfg. Co., Inc. of Mequon, Wis.

Referring to FIG. 13, still another important feature of the present invention resides in the provision of a plurality of longitudinally spaced magnets 52 that are connected to the bottom surface 60 of body 56. In use, these magnets permit the level to be conveniently, removably connected to any ferrous structure that is being leveled. Magnets 52 are readily commercially available from several sources including Applied Magnets of Plano, Tex.

As illustrated in FIGS. 9 and 17, the level of this latest form of the invention is particularly useful in leveling a length of conduit, such as conduit “S”. When so used, one end of the conduit is inserted into the slot 62a and is secured in position using the novel workpiece securement assembly 90. As best seen in FIG. 14 of the drawings, first end portion 62 of body 56 is provided with a bore 92 having an upper threaded portion 92a and a lower portion 92b. In this embodiment of the invention, the workpiece securement assembly 90 comprises a structure engaging member provided in the form of a generally spherical member 94 that is rotatably mounted within the lower portion 92b of the threaded bore, a threaded connector, shown here as a conventional cap screw 96 is mounted within the upper portion 92a of the threaded bore and a coil spring 98 disposed within the threaded bore intermediate the structure engaging member 94 and the threaded connector 96. As indicated in FIGS. 10 and 14, a portion of spherical member 94 extends outwardly of the threaded bore and into the slot 62a. With this construction, when one end of the work piece, or conduit “S”, is inserted into the slot 62a, spherical member 94 will rotatably engage the conduit wall and will be forced inwardly of the threaded bore against the urging of the coil spring. When the end of the conduit is seated within slot 62a, the coil spring will urge the spherical member into engagement with the outer surface of the conduit and will function to secure the conduit in position within the slot.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention as set forth in the following claims.

1. A level for determining the orientation of a structure comprising:
(a) a body having a top surface, a bottom surface and first and second end portions, said body having at least one vial chamber;
(b) a bubble vial disposed within said vial chamber of said body; and
(c) a connector mechanism for securing said bubble vial within said vial chamber, said connector mechanism comprising:
(i) a female receptor connected to said body proximate said vial chamber, said female receptor having a pair of circumferentially spaced apart generally L-shaped slots; and
a male connector operably associated with said bubble vial, said male connector being rotatably receivable within said female receptor and having a pair of circumferentially spaced apart radial pins receivable within said generally L-shaped slots.

2. The level as defined in claim 1 further including a spring disposed between said male connector and said bubble vial.

3. The level as defined in claim 1 in which said male connector is generally cylindrical.

4. The level as defined in claim 1 in which said male connector is provided with a transversely extending slot.

5. The level as defined in claim 1 further including at least one magnet connected to said bottom surface of said body.

6. The level as defined in claim 1 further including a bulls-eye level connected to said top surface of said body.

7. The level as defined in claim 1 in which said first end portion of said body is slotted and is provided with a threaded bore and in which said level further includes a work piece engaging assembly carried by said first end portion of said body, said work piece engaging assembly comprising:
(a) a structure engaging member rotatably mounted within said threaded bore;
(b) a threaded connector mounted within said threaded bore; and
(c) a spring disposed within said threaded bore intermediate said structure engaging member and said threaded connector.

8. The level as defined in claim 7 in which said structure engaging member is generally spherical in shape.

9. The level as defined in claim 7 in which said threaded connector comprises a cap screw having a slotted upper surface.

10. A level for determining the orientation of a structure comprising:
(a) a body having a top surface, a bottom surface, a slotted first end portion and a second portion, said body having at least a plurality of vial chambers;
(b) a bubble vial disposed within each of said vial chambers of said body; and
(c) a connector mechanism for securing said bubble vials within each of said vial chambers, said connector mechanism comprising:
(i) a female receptor connected to said body proximate each of said vial chambers, said female receptor having a pair of circumferentially spaced apart generally U-shaped slots; and
(ii) a generally cylindrically shaped male connector operably associated with each of said bubble vials, said male connector being rotatably receivable within said female receptor and having a pair of circumferentially spaced apart radial pins receivable within said generally L-shaped slots.

11. The level as defined in claim 10 further including a spring disposed between said male connector and said bubble vial.

12. The level as defined in claim 10 in which said bottom surface of said body is provided with a longitudinally extending, generally “V” shaped groove.

13. The level as defined in claim 10 further including at least one magnet connected to said bottom surface of said body.

14. The level as defined in claim 10 further including a bulls-eye level connected to said top surface of said body.

15. The level as defined in claim 10 in which said first end portion of said body is provided with a threaded bore and in which said level further includes a work piece engaging assembly carried by said first end portion of said body, said work piece engaging assembly comprising:
(a) a structure engaging member rotatably mounted within said threaded bore;
(b) a threaded connector mounted within said threaded bore; and
(c) a spring disposed within said threaded bore intermediate said structure engaging member and said threaded connector.

16. The level as defined in claim 7 in which said structure engaging member is generally spherical in shape.

17. The level as defined in claim 7 in which said threaded connector comprises a cap screw having a slotted upper surface.

18. A level for determining the orientation of a structure comprising:
(a) a body having a top surface, a bottom surface, a slotted first end portion having a threaded bore and a second portion, said body having at least a plurality of vial chambers;
(b) a bubble vial disposed within each of said vial chambers of said body;
(c) a connector mechanism for securing said bubble vials within each of said vial chambers, said connector mechanism comprising:
(i) a female receptor connected to said body proximate each of said vial chambers, said female receptor having a pair of circumferentially spaced apart generally U-shaped slots;
(ii) a generally cylindrically shaped male connector operably associated with each of said bubble vials, said male connector being rotatably receivable within said female receptor and having a pair of circumferentially spaced apart radial pins receivable within said generally L-shaped slots; and
(iii) a coil spring disposed between said male connector and said bubble vial; and
(d) a work piece engaging assembly carried by said slotted first end portion of said body, said work piece engaging assembly comprising:
(i) a generally spherical shaped structure engaging member rotatably mounted within said threaded bore of said slotted first end portion of said body;
(ii) a threaded cap screw mounted within said threaded bore of said slotted first end portion of said body; and
(iii) a spring disposed within said threaded bore of said slotted first end portion of said body intermediate said structure engaging member and said threaded connector.

19. The level as defined in claim 10 further including at least one magnet connected to said bottom surface of said body.

20. The level as defined in claim 10 in which said bottom surface of said body is provided with a generally “V” shaped groove.

21. A level for determining the orientation of a structure comprising:
(a) a body having a top surface, a bottom surface, a first slotted end portion having a threaded bore and a second end portion, said body having at least one vial chamber;
(b) a bubble vial disposed within said vial chamber of said body; and
(c) a work piece engaging assembly carried by said slotted first end portion of said body, said work piece engaging assembly comprising:
(i) a generally spherical shaped structure engaging member rotatably mounted within said threaded bore of said slotted first end portion of said body;
(ii) a threaded cap screw mounted within said threaded bore of said slotted first end portion of said body; and
(iii) a spring disposed within said threaded bore of said slotted first end portion of said body intermediate said structure engaging member and said threaded connector.
